(19) United States
(12) Patent Application Publication
(10) Pub. No.: US 2020/0021321 A1
(43) Pub. Date: Jan. 16, 2020

(54) IN-SERVICE MONITORING OF DFS SIGNALS DURING ANALOG VIDEO TRANSMISSION

(71) Applicant: Amimon Ltd., Ra'anana (IL)

(72) Inventor: Zvi Reznic, Tel Aviv (IL)

(21) Appl. No.: 16/490,894

(22) PCT Filed: Mar. 28, 2018
(86) PCT No.: PCT/IB2018/052138

§ 371 Date: Sep. 4, 2019

Related U.S. Application Data
(60) Provisional application No. 62/480,553, filed on Apr. 3, 2017.

(51) Int. Cl. H04B 1/10; H04B 7/08; G01S 7/00; H04L 25/02; H04B 7/0413; G01S 7/02

(52) U.S. Cl. CPC H04B 1/1027; H04B 7/086; G01S 7/006; H04L 25/022; H04B 7/0413; G01S 7/021; H04L 25/0204

(57) ABSTRACT

An in-service radar detection unit for a wireless analog video receiver includes a channel estimator, a signal recovery vector creator, a signal estimator, a radar detector, and a control transmitter. The channel estimator generates a channel estimation between a transmitter and a receiver from a plurality of signals received on a plurality of antennas. The signal recovery vector creator creates a non-zero nulling vector from the channel estimation. The signal estimator utilizes the nulling vector to restore an additional signal, other than an analog video, from the received signals. The radar detector detects a radar signal in the additional signal, and the control transmitter transmits an indication of the detected radar signal using at least one of the antennas.

### CROSS-REFERENCE TO RELATED APPLICATIONS

This application claims priority from U.S. Provisional Patent Application No. 62/480,553, filed 3 Apr. 2017, all of which are hereby incorporated in their entirety by reference.

### FIELD OF THE INVENTION

The present invention relates to dynamic frequency selection (DFS) generally and to DFS in service monitoring (ISM) during first person view (FPV) control of unmanned aerial vehicles (UAV) in particular.

### BACKGROUND OF THE INVENTION

First-person view (FPV) is a method used to control a radio-controlled vehicle from the driver or pilot's view point. It is most commonly used to pilot a radio-controlled aircraft or other type of unmanned aerial vehicles (UAV) such as drones. The vehicle is either driven or piloted remotely from a first-person perspective via an onboard camera, fed wirelessly to special video FPV goggles or to a video monitor. FPV has become increasingly common and is a fast growing activity amongst remote controlled (RC) aircraft enthusiasts.

FIG. 1 to which reference is now made, is an illustration of an FPV setup which primarily comprises an airborne component 100 and a ground component 200, typically called a “ground station”. Airborne component 100 may include a small video camera 110, mounted on the controlled vehicle, and an analogue video transmitter 120 with a live video down-link. Ground component 200 may include a live analogue video receiver 210, matching the frequency of the transmitter on the airborne component, and a display 220 which may be video goggles, a portable monitor 220′ and the like.

Analogue video transmitter 120 may transmit video from the airborne component using an analogue wireless (radio) technology. The most common frequencies used for video transmission are: 900 MHz, 1.2 GHz, 2.4 GHz, and 5.1-5.8 GHz. The 5.1-5.8 GHz frequency is growing in popularity for UAVs as it is extremely cheap to buy and the antenna may be relatively small, allowing for better portability.

The use and allocation of all radio frequency bands of the electromagnetic spectrum is regulated by the government in most countries. For example, some parts of the 5 GHz frequency band are allocated by most governments to radar systems. Different channel allocation schemes may be used to allocate the radio frequencies, and the channel allocation scheme may be static, where the channel is manually assigned, or dynamic, where the channel is dynamically allocated.

Dynamic frequency selection (DFS) is a mechanism allowing unlicensed devices to use the 5 GHz frequency bands, already allocated to radar systems, while providing precedence to radar signals over the unlicensed device signals. The DFS mechanism is required by law and/or regulation in some parts of the 5 GHz band. It may be appreciated that a conventional radar signal may be identified since it has a specific known pattern of repeated burst of high frequency pulses. Interference to the radar is avoided in DFS by detecting the presence of a radar system on the used channel and vacating the channel if the level of the radar is above a certain threshold. The unlicensed device may continue transmitting on an alternate channel.

For operating in certain frequencies within the 5 GHz band, analogue video receiver 210 and analogue video transmitter 120 should comply with DFS and should detect possible radar signals inside its channel and vacate the channel once a radar signal is detected. Unfortunately, the state of the art low-latency wireless video in FPV is frequently implemented with analog transmitters which almost fully utilize the channel, that is, they transmit most of the time, (almost 100% duty cycle), and thus, may miss radar signals.

Digital methods with low duty cycles may be utilized to facilitate radar signal detection during video transmission. One design choice may be to compress the video to a very low bit rate using a compression mechanism. Such compression may reduce the amount of data transmitted over the channel. One example of a compression standard with a low bit rate is H.264. Another design choice may be to use high-bandwidth (BW) communication, e.g. Wi-Fi with 80 MHz BW.

Low bit-rate and high BW design choices may leave the channel free most of the time during which radar detection, as required by DFS regulation, may be implemented; however, in these mechanisms, the video quality may be degraded due to the low bit rate. In addition, using Wi-Fi in this way may still degrade ISM performance due to data re-transmission.

### SUMMARY OF THE PRESENT INVENTION

There is provided, in accordance with a preferred embodiment of the present invention, an in-service radar detection unit for a wireless analog video receiver. The unit includes a channel estimator, a signal recovery vector creator, a signal estimator, a radar detector and a control. The channel estimator generates channel estimation between a transmitter and the receiver from plurality of signals received on a plurality of antennas. The signal recovery vector creator creates a non-zero nulling vector from the channel estimation. The signal estimator utilizes the nulling vector to restore an additional signal, other than an analog video, from the received signals. The radar detector detects a radar signal in the additional signal, and the control transmitter transmits an indication of the detected radar signal using at least one of the antennas.

Further, in accordance with a preferred embodiment of the present invention, the signal recovery vector creator creates an equalization vector, and also includes a video signal estimator to restore the analog video from the received signals using the equalization vector.

Still further, in accordance with a preferred embodiment of the present invention, the unit also includes an analog video handler to display the restored video on a display.

Additionally, in accordance with a preferred embodiment of the present invention, one of the plurality of antennas is used only by the control transmitter.

Moreover, in accordance with a preferred embodiment of the present invention, the unit is located in a ground component of a drone.

There is also provided, in accordance with a preferred embodiment of the present invention, a method for in service radar detection in a wireless analog video system. The method includes receiving multiple signals from multiple antennas, generating a channel estimation from the received signals, deriving a non-zero nulling vector from at least the channel estimation, generating an additional signal from the received multiple signals and the nulling vector, detecting a radar signal in the additional signal, and transmitting an indication of the detected radar signal using at least one of the antennas.

Furthermore, in accordance with a preferred embodiment of the present invention, the indication is receivable by an analog video transmitter for compliance with dynamic frequency selection (DFS) slave regulations.

Still further, in accordance with a preferred embodiment of the present invention, the analog video transmitter stops transmitting on a channel estimated by the channel estimation upon reception of the indication, and starts transmitting on another channel.

There is also provided, in accordance with a preferred embodiment of the present invention, a method for in service monitoring in analog video radio transmissions. The method includes estimating a channel from received multiple-input and multiple-output (MIMO) radio signals, generating a non-zero nulling vector from the estimated channel, creating an additional signal from the received signals and the nulling vector, and identifying unexpected signals in the additional signal.

Furthermore, in accordance with a preferred embodiment of the present invention, the method includes sending an indication regarding the additional signal.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of an FPV setup of an airborne component and a ground component;

FIG. 2 is a schematic illustration of an of an FPV system;

FIGS. 3A and 3B are schematic illustrations of two MIMO channel matrices;

FIGS. 4A and 4B are schematic illustrations of alternative embodiments of a video source unit, constructed and operative in accordance with a preferred embodiment of the present invention; and

FIGS. 5A and 5B are schematic illustrations of alternative embodiments of a video display unit, constructed and operative in accordance with a preferred embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicant has realized that it may be useful to use analog video transmission for maintaining low-latency and low cost first pilot view (FPV) systems. Applicant has further realized that video quality for FPV may be maintained using analog video while complying with DFS regulations in the 5 GHz frequency band.

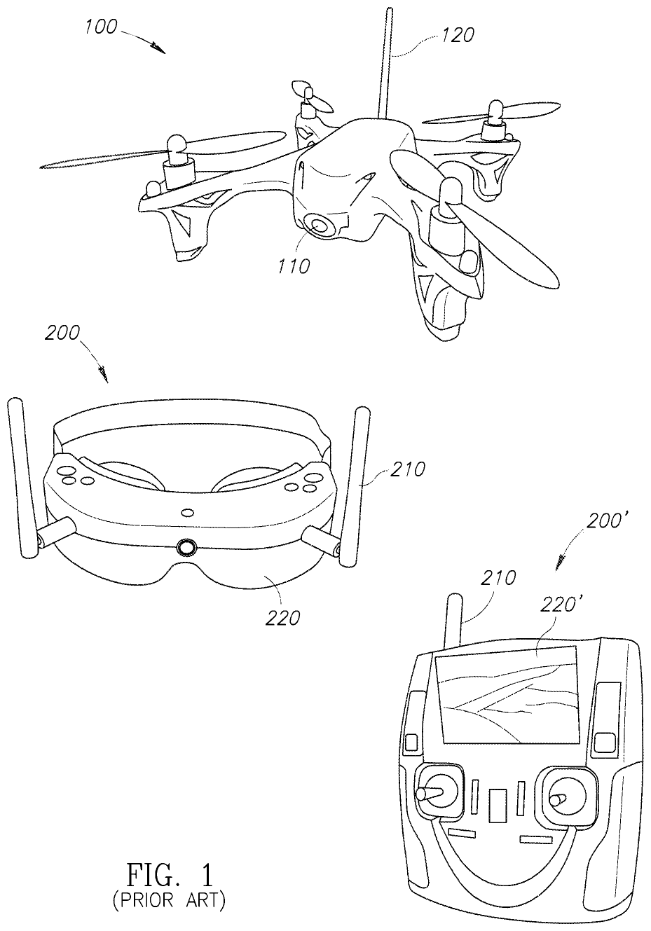

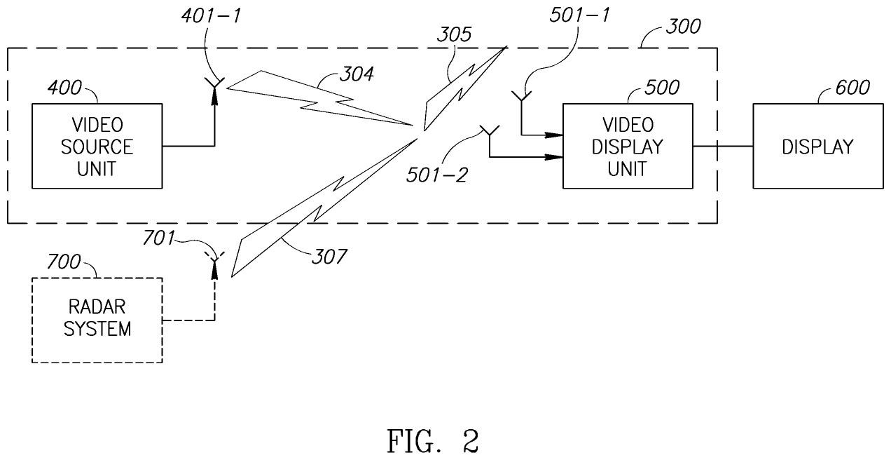

FIG. 2, to which reference is now made, is a schematic illustration of an FPV system 300 that comprises a video source unit 400, (installed on airborne component 100 of FIG. 1) capable of transmitting analog video and equipped with at least one antenna 401-1, a video display unit 500 (installed on ground component 200 of FIG. 1) capable of receiving signals, equipped with at least two antennas 501-1 and 501-1 operating on the same channel as video source unit 400. Video display unit 500 is connected to a display 600 capable of displaying the received video. A radar system 700, equipped with at least one antenna 701, may transmit a signal on the same channel used by FPV system 300. Radio signal 304 represents a signal sent by video source unit 400 and radio signal 307 represents the signal sent by radar system 700. Radio signal 305 represents the signal received on both antennas 501-1 and 501-1.

The signals transmitted from video source unit 400 may be received on both antennas 501-1 and 501-2 of video display unit 500. Signals sent from radar system 700 may also be received on both antennas 501-1 and 501-2 of video display unit 500 thus signal 305 may be a combination of radio signal 304 and radio signal 307. The known in the art, multiple-input and multiple-output (MIMO) method may use multiple transmit antennas in video source unit 400 and multiple receive antennas in video display unit 500.

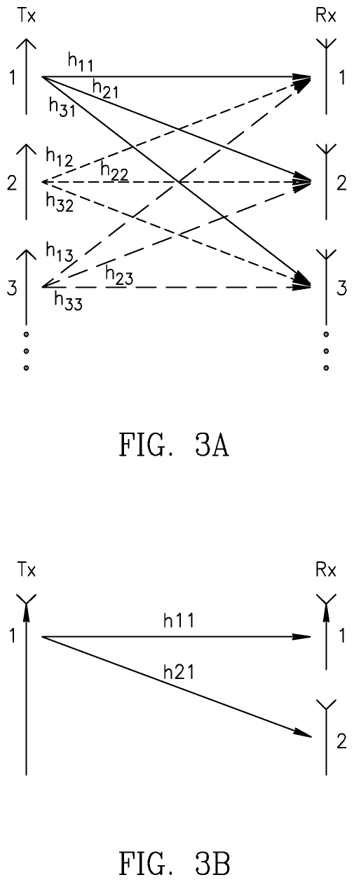

FIGS. 3A and 3B schematically illustrate a MIMO channel matrix representing a channel between transmitting and receiving antennas. FIG. 3A illustrates a general MIMO configuration with multiple transmitting antennas and multiple receiving antennas. The channel between the transmitting and the receiving antennas may be expressed by a matrix, H, each element hᵢⱼ of H describes a path between a transmit antenna j and a receive antenna i. FIG. 3B illustrates a MIMO channel vector h that may be created between a single transmitting antenna and a plurality of receiving antennas. In the illustration the number of receiving antennas is two however the number of receiving antennas may be larger.

Returning to FIG. 2, signal 305, received on both antennas (501-1 and 501-2), may be analyzed and if a radar signal is identified by video display unit 500, it may send an indication in the uplink direction instructing video source unit 400 to cease transmitting on the current channel. Video source unit 400 may break the transmission over the existing channel and optionally may start transmitting on an alternate channel.

It may be appreciated that the same channel between video source unit 400 and video display unit 500 may be used for bi-directional communication, where the downlink communication may include analog video transmission, and the uplink communication may include control signals (from which one could be a radar indication). Channel sharing between downlink and uplink can be performed, for example, with time division multiplexing (TDM). The common channel may be occupied by a downlink transmission most of the time.

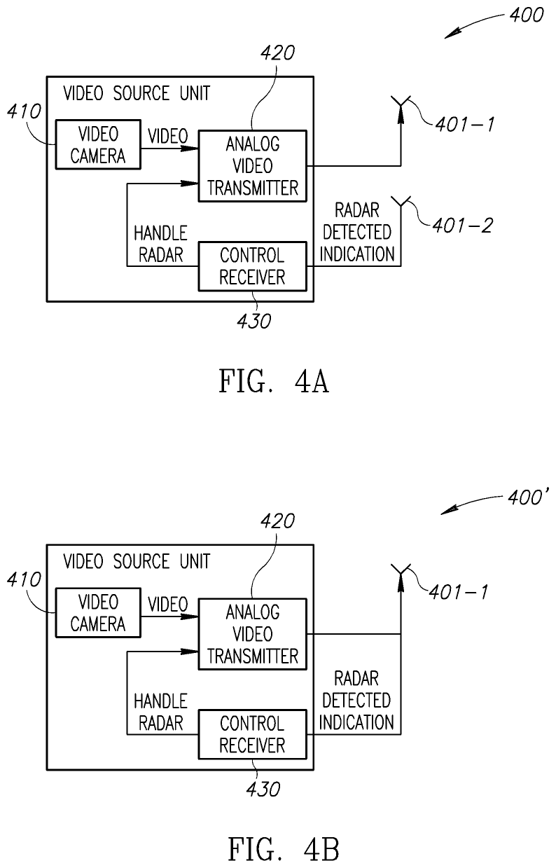

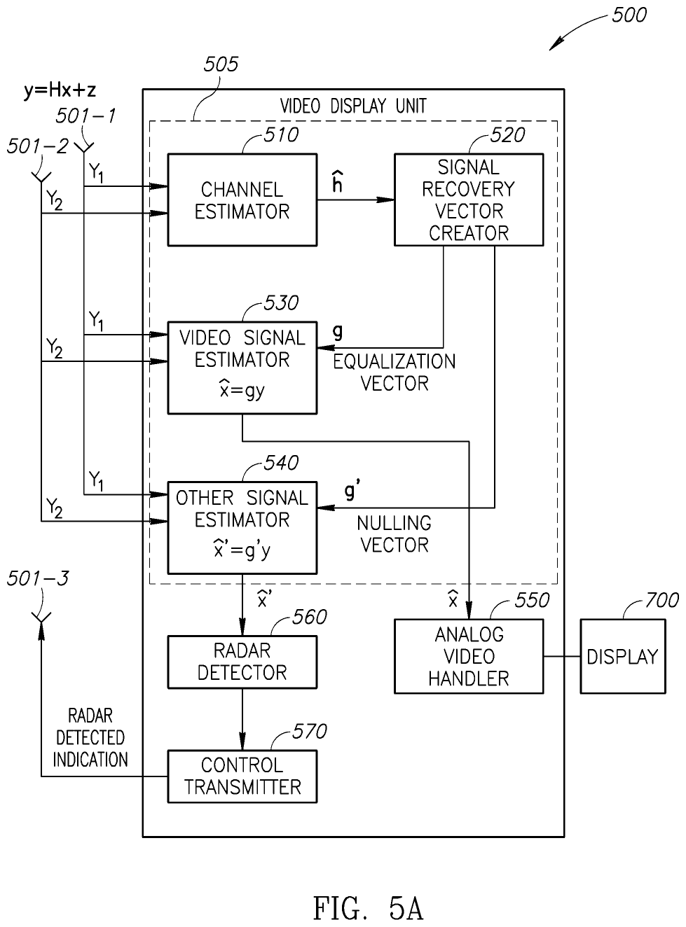

FIGS. 4A and 4B, to which reference is now made, are schematic illustrations of alternative embodiments of video source unit 400. In FIG. 4A, video source unit 400 comprises a transmitting antenna 401-1 and a receiving antenna 401-2; a video camera 410, an analog video transmitter 420 and a control receiver 430. Alternatively, a single antenna 401-1 may be used for both downlink and uplink, a configuration that is illustrated in FIG. 4B.

Video camera 410 may take a video and transfer the captured data to analogue video transmitter 420 that may further transmit it via transmitting antenna 401-1 over a selected radio channel. Antenna 401-2 (of FIG. 4A) may receive a radio signal and pass it to control receiver 430. The received signal may be identified by control receiver 430 as a “radar detected” indication. In this case, control receiver 430 may instruct analog video transmitter 420 to handle it. As a result of receiving the “radar detected” indication, video transmitter 420, complying with the DFS slave regulation, may cease transmitting the analog video on the selected channel. Video transmitter 420 may further select another channel to transmit the video on, or may perform any other operation after freeing the channel on which the video was transmitted.

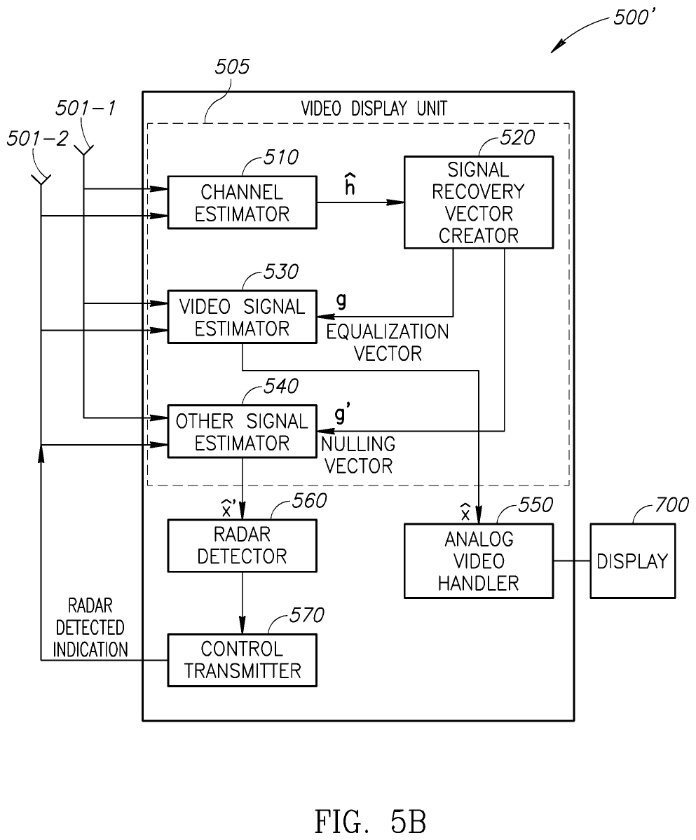

FIGS. 5A and 5B, to which reference is now made, are schematic illustrations of alternative embodiments of video display unit 500. In FIG. 5A, video display unit 500 comprises two receiving antennas 501-1 and 501-2 and one transmitting antenna 501-3; a receiver 505; an analog video handler 550; a radar detector 560 and a control transmitter 570. Alternatively, one of the receiving antennas 501-1 or 501-2 may be used for both receive (in the downlink direction) and transmit (in the uplink direction), a configuration that is illustrated in FIG. 5B in which antenna 501-2 is used for both transmitting and receiving.

Receiver 505 may estimate the video transmission channel matrix H, described in more detail hereinbelow. Using the estimated matrix H, receiver 505 may create an equalization vector g to recover the video signal, and a nulling vector g′ to recover any other possible signal, other than the video signal. Receiver 505 further comprises a channel estimator 510; a signal recovery vectors creator 520; a video signal estimator 530 and an additional signal estimator 540;

Channel estimator 510 may estimate the video transmission channel matrix H. A MIMO channel measurement session may be established between video source unit 400 and video display unit 500 (of FIG. 2) prior to the actual video transmission, in order to learn the channels between transmitting antenna 401-1 and receiving antennas 501-1 and 501-2. Additional MIMO channel measurement sessions may be established between video source unit 400 and video display unit 500 during the actual video transmission to update and refresh the estimation of the channels between transmitting antenna 401-1 and receiving antennas 501-1 and 501-2. Channel estimator 510 may learn the channel matrix during any of these channel measurement sessions.

The received signal may be expressed by a vector y whose elements yᵢ describe the received signal at each antenna i. When system 300 (of FIG. 2) comprises one transmit antenna and two receive antennas, the matrix channel H is actually a vector h=[h₁₁, h₂₁].

The signal vector y may be expressed as a general signal vector in equation 1:

y=Hx+z Equation 1

where x is a vector whose elements xⱼ describe the transmit signals from each transmit antenna j and z is a vector whose elements zᵢ describe the additive noise, at each of receive antennas i. In FIGS. 5A and 5B video display unit 500 is configured with two receiving antennas, 501-1 and 501-2.

Signal recovery vectors creator 520 may use channel matrix H (or vector h), created by channel estimator 510, to create two signal recovery vectors: an equalization vector g and a nulling vector g′. The equalization vector may be used to recover the video signal and the nulling vector may be used to recover any additional signal, other than video, received on the channel.

The equalization vector g may be used to restore the approximate signal \hat{x} of the original transmitted video x. Signal recovery vectors creator 520 may create equalization vector g from the estimated channel vector h via any suitable method, such as maximum ratio combining (MRC), described by equation 2:

$$g = \frac{{\hat{h}}^{*}}{{\hat{h}}^{*} \hat{h}} \qquad Equation 2$$

where ĥ* is the transpose matrix/vector of channel matrix/vector estimation ĥ.

Video signal estimator 530 may use the calculated equalization vector g to recover an approximation signal \hat{x} of the original signal x from the received signal y, as defined in equation 3:

\hat{x}=gy Equation 3

It may be appreciated that the presence of a radar signal, in addition to a video signal, may cause a degradation in the quality of the rendered video at the receiver side, since the received signal y is a sum of all received signals; however, since radars are rare, and their pulses are short, the degraded video quality may rarely exist and only for a short period of time.

Other signal estimator 540 may utilize nulling vector g′ to remove the video signal from the received signal. Any remaining signal may include some background noise and/or interference, and/or a radar signal that may be sent from a nearby radar system

Signal recovery vectors creator 520 may construct the nulling vector g′ using the estimated vector ĥ such that both conditions 1 and 2, defined below, are met:

g′>0 Condition 1

g′ĥ=0 Condition 2

One example of g′ that meets Condition 1 is the normalized vector |g′|=1.

Other signal estimator 540 may restore a signal \hat{x}′, which is an estimate of any additional signal received, other than video. Other signal estimator 540 may use the nulling vector g′ to restore any additional signal according to equation 4:

\hat{x}′=g′y Equation 4

As already discussed hereinabove, the received signal y may be the sum of a video signal sent from video source unit 400 and a radar signal sent from radar system 700 (of FIG. 2) and any additional noise or interference or the like. When the received signal is a sum of two transmitted signals, it may be expressed by equation 5:

y=hx+h′x′+z Equation 5

where h is the channel vector between antenna 401-1 of video source unit 400 (of FIG. 2) and the receiving antennas 501-1 and 501-2; x is the transmitted video signal; h′ is the channel vector between antenna 701 of radar system 700 (of FIG. 2) and the receiving antennas 501-1 and 501-2 and x′ is the transmitted radar signal.

Video signal estimator 530 may use equalization vector g to restore video signal \hat{x} according to equation 3 described hereinabove (\hat{x}=gy).

Analog video handler 550 may receive the restored signal 2 and may render the video on any rendering equipment such as on digital googles, on a display and the like.

At the same time, radar detector 560 may analyze the recovered signal \hat{x}′ and may detect the existence of a radar signal inside the recovered signal \hat{x}′. Radar signals may be detected in \hat{x}′ by using, for example, power-per-bin detector described in U.S. Pat. No. 7,702,044 B2 titled “Radar detection and dynamic frequency selection” by Nallapureddy et al. or any other radar signal identification mechanism known in the art.

If a radar signal is detected, control transmitter 570 may send a “radar detected indication”. As described hereinabove, control receiver 430 (FIGS. 4A and 4B), may react to a received “radar detected” indication by changing the transmitting channel and by doing so, FPV system 300 may comply with the DFS regulations and laws relevant to unlicensed devices operating on the 5 Ghz band.

It may be appreciated that any transmission and reception of control signals may be handled by the same antennas used for transmission and reception of video signals (i.e. sharing antenna for both video and control). Video source unit 400 may have a single antenna, used for both transmitting and receiving signals. The different functionality, send and receive, may be controlled by a switch. Alternatively, video display unit 500 may be equipped with multiple, minimum 2, receiving antennas from which one of the receiving antennas may be used also to transmit control signals.

It may be appreciated that using the channel matrix, learned by video display unit 500 to create a nulling vector may enable other signal estimator 540 to extract signals other than the expected video from any received signal, and may provide the functionality needed to support the DFS laws and regulations relevant to unlicensed frequencies in the 5 Ghz band. It may also be appreciated that the mechanism described hereinabove may provide an implementation of a real “in service monitoring” (ISM) for radar using concurrent signal processing.

It may be appreciated that multiple-input and multiple-output (MIMO), method for multiplying the capacity of a radio link using multiple transmit and receive antennas, is used in IEEE standards IEEE802.11n and IEEE802.11ac. These standards provide a practical technique for sending and receiving more than one data signal simultaneously over the same radio channel by exploiting multipath propagation.

While the technique defined in the standard requires the coordination of a learning phase with all transmitting units, the invention described hereinabove does not require estimating the channel between the radar and the receiver unit. In addition, the Multi-User MIMO technique, also defined in IEEE802.11ac, defines a method to simultaneously receive signals from two or more transmit units and requires the coordination of clocks of the different transmitting units; the present invention on the other hand does not require any clock coordination.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a general purpose computer of any type such as a client/server system, mobile computing devices, smart appliances or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. The resultant apparatus when instructed by software may turn the general purpose computer into inventive elements as discussed herein. The instructions may define the inventive device in operation with the computer platform for which it is desired. Such a computer program may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. An in-service radar detection unit for a wireless analog video receiver, the unit comprising:
a channel estimator to generate a channel estimation between a transmitter and said receiver from a plurality of signals received on a plurality of antennas;
a signal recovery vector creator to create a non-zero nulling vector from said channel estimation;
an other signal estimator to utilize said nulling vector to restore an additional signal other than an analog video from said received signals;
a radar detector to detect a radar signal in said additional signal; and
a control transmitter to transmit an indication of said detected radar signal using at least one of said antennas.

2. A unit according to claim 1 wherein said signal recovery vector creator to create an equalization vector and also comprising:
a video signal estimator to restore said analog video from said received signals using said equalization vector.

3. A unit according to claim 2 and also comprising an analog video handler to display said restored video from said video signal estimator on a display.

4. A unit according to claim 1 wherein one of said plurality of antennas is used only by said control transmitter.

5. A unit according to claim 1 wherein said unit is located in a ground component of a drone.

6. A method for in service radar detection in a wireless analog video system comprising:
receiving multiple signals from multiple antennas;
generating a channel estimation from said received signals;
deriving a non-zero nulling vector from at least said channel estimation;
generating an additional signal from said received multiple signals and said nulling vector;
detecting a radar signal in said additional signal; and
transmitting an indication of said detected radar signal using at least one of said antennas.

7. The method of claim 6 and wherein said indication is receivable by an analog video transmitter for compliance with dynamic frequency selection (DFS) slave regulations.

8. The method of claim 7 and wherein said analog video transmitter stops transmitting on a channel estimated by said channel estimation upon reception of said indication and starts transmitting on another channel.

9. A method for in service monitoring in analog video radio transmissions, the method comprising:
estimating a channel from received multiple-input and multiple-output (MIMO) radio signals;
generating a non-zero nulling vector from said estimated channel;
creating an additional signal from said received signals and said nulling vector; and
identifying unexpected signals in said additional signal.

10. The method of claim 9 and also sending an indication regarding said additional signal.
